(19) United States
(12) Patent Application Publication
(10) Pub. No.: US 2014/0340480 A1
(43) Pub. Date: Nov. 20, 2014

(54) APPARATUS AND METHOD FOR MANAGING DELAY IN RECEIVING THREE-DIMENSIONAL (3D) IMAGE

(71) Applicants: Electronics and Telecommunications Research Institute, Daejeon (KR); Kookmin University Industry Academy Cooperation Foundation, Seoul (KR); Hidea Solutions Co., Ltd, Seoul (KR)

(72) Inventors: Joo Young LEE, Daejeon (KR); Sung Hoon KIM, Daejeon (KR); Hyon Gon CHOO, Daejeon (KR); Jin Soo CHOI, Daejeon (KR); Jin Woong KIM, Daejeon (KR); Suk Jin HONG, Seoul (KR); Jung Keun OH, Seoul (KR); Jin Suk KWAK, Daejeon (KR); Min Suk LEE, Daejeon (KR); Dong Wook KANG, Seoul (KR); Kyeong Hoon JUNG, Seoul (KR)

(73) Assignees: Electronics and Telecommunications Research Institute, Daejeon (KR); Kookmin University Industry Academy Cooperation Foundation, Seoul (KR); Hidea Solutions Co., Ltd, Seoul (KR)

(21) Appl. No.: 14/279,625

(22) Filed: May 16, 2014

(30) Foreign Application Priority Data
May 16, 2013 (KR) 10-2013-0055788

(51) Int. Cl. H04N 13/00

(52) U.S. Cl. CPC H04N 13/0018
USPC 348/43

(57) ABSTRACT

An apparatus for managing a delay in receiving a three-dimensional (3D) image may include an image receiver to receive a left image and a right image for 3D image synthesis, and a substitution content output unit to output substitution content during a waiting time caused by a difference between points in time at which the left image and the right image are received.

### CROSS-REFERENCE TO RELATED APPLICATION

This application claims the benefit of Korean Patent Application No. 10-2013-0055788, filed on May 16, 2013, in the Korean Intellectual Property Office, the disclosure of which is incorporated herein by reference.

### BACKGROUND

1. Field of the Invention

The present invention relates to an apparatus and method for managing a delay in receiving a three-dimensional (3D) image, and more particularly, to a reception delay managing apparatus and method that may manage a reception delay of a left image and a right image received for 3D image synthesis.

2. Description of the Related Art

A binocular three-dimensional (3D) image broadcasting system may transmit a left image stream and a right image steam simultaneously to a receiver to provide a 3D television (TV) broadcasting service. The receiver receiving a left image and a right image may provide a 3D image to a viewer through 3D image synthesis.

The 3D image broadcasting system may differentiate processing delay times of the left image stream and the right image stream, depending on a process, for example, encoding of the left image and the right image, multiplexing, modulating, transmitting, demodulating, demultiplexing, decoding, and the like. In particular, when the 3D image broadcasting system transmits the left image and the right image to the receiver using different schemes, a difference between the processing delay times of the left image and the right image may result in a delay time for 3D image synthesis.

In addition, the receiver may synchronize the left image and the right image in order to simultaneously output the received left image and the right image. The receiver may simultaneously provide, to the viewer, the left image and the right image that are captured at the same time. A stream provided to the viewer when the receiver is operated in a two-dimensional (2D) mode may be referred to as a base view stream, and a remaining stream used for 3D image synthesis may be referred to as an additional view stream. A base view and an additional view may correspond to the left image and the right image, respectively.

Due to the reception and processing delay times of the left image and the right image, the receiver may not provide a 3D image to the viewer until a right image matching an initially received left image or a left image matching an initially received right image is received.

Accordingly, the receiver may demand a method of enabling a viewer to view normal and seamless content corresponding to a left image and a right image of which reception and processing delay times are different.

### SUMMARY

An aspect of the present invention provides an apparatus for managing a delay in receiving a three-dimensional (3D) image that may output substitution content during a waiting time caused by a difference between points in time at which a left image and a right image for 3D image synthesis are received, thereby effectively solving a delay in viewing the 3D image for a user viewing the 3D image.

Another aspect of the present invention also provides an apparatus for managing a delay in receiving a 3D image that may insert an advertisement as substitution content to be output during a waiting time caused by a difference between points in time at which a left image and a right image are received, thereby easily creating a profit model of an advertiser through the inserted advertisement.

According to an aspect of the present invention, there is provided an apparatus for managing a delay in receiving a 3D image, the apparatus including an image receiver to receive a left image and a right image for 3D image synthesis, and a substitution content output unit to output substitution content during a waiting time caused by a difference between points in time at which the left image and the right image are received.

The apparatus may further include an additional data receiver to receive additional data to be output as the substitution content during the waiting time.

According to another aspect of the present invention, there is also provided a method of managing a delay in receiving a 3D image, the method including receiving a left image and a right image for 3D image synthesis, and outputting substitution content during a waiting time caused by a difference between points in time at which the left image and the right image are received.

The method may further include receiving additional data to be output as the substitution content during the waiting time.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a reception delay managing apparatus according to an exemplary embodiment;

FIG. 2 is a block diagram illustrating a configuration of a reception delay managing apparatus according to an exemplary embodiment;

FIG. 3 is a diagram illustrating a process of determining substitution content according to an exemplary embodiment;

FIG. 4 is a diagram illustrating a process of determining substitution content according to another exemplary embodiment;

FIG. 5 is a diagram illustrating a process of outputting substitution content according to an exemplary embodiment;

FIG. 6 is a diagram illustrating a process of outputting substitution content according to another exemplary embodiment;

FIG. 7 is a diagram illustrating a process of outputting substitution content according to still another exemplary embodiment;

FIG. 8 is a diagram illustrating a method of displaying a waiting time for three-dimensional (3D) image synthesis according to an exemplary embodiment; and

FIG. 9 is a flowchart illustrating a reception delay managing method according to an exemplary embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

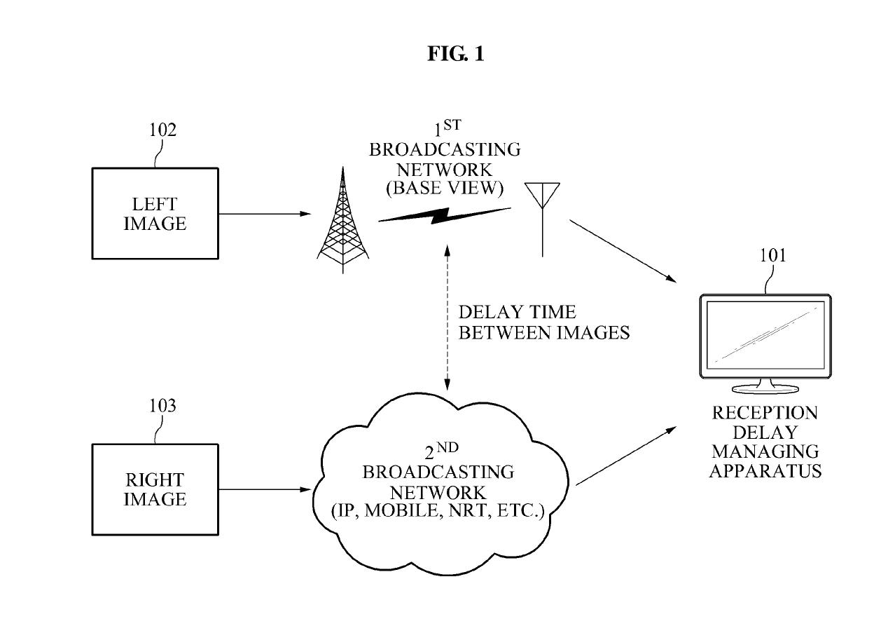

FIG. 1 is a diagram illustrating a reception delay managing apparatus 101 according to an exemplary embodiment.

Referring to FIG. 1, the reception delay managing apparatus 101 may receive a left image 102 and a right image 103 for three-dimensional (3D) image synthesis. The left image 102 and the right image 103 may correspond to two separate images that are acquired by photographing a single object and to be used for 3D image synthesis. The left image 102 may refer to an image of the single object to be viewed with a left eye of a user viewing a 3D image. The right image 103 may refer to an image of the single object to be viewed with a right eye of the user viewing the 3D image. In addition, the left image 102 and the right image 103 may correspond to a base view or an additional view to be used for 3D image synthesis. The base view may correspond to a stream to be provided to a viewer when the reception delay managing apparatus 101 is operated in a two-dimensional (2D) mode. The additional view may correspond to a stream to be used for 3D image synthesis to be performed based on the base view. For example, the left image 102 may be the base view, and the right image 103 may be the additional view. Left and right positions of the base view and the additional view may be changed depending on an actual implementation of the reception delay managing apparatus 101.

The reception delay managing apparatus 101 may receive the left image 102 and the right image 103 through different broadcasting networks. In particular, the reception delay managing apparatus 101 may receive the left image 102 and the right image 103 through a first broadcasting network and a second broadcasting network. The first broadcasting network may refer to a broadcasting network through which the base view may be received. The second broadcasting network may refer to a broadcasting network through which the additional view may be received. For example, the second broadcasting network may include a broadband network, a mobile broadcasting network, a cable broadcasting network, a satellite broadcasting network, a non-real-time (NRT) network, and the like.

Since the reception delay managing apparatus 101 may receive the left image 102 and the right image 103 through different broadcasting networks, reception delay times may differ between the left image 102 and the right image 103. Thus, a 3D image synthesis delay time may occur. The reception delay times differing between the left image 102 and the right image 103 may be caused by a process such as, for example, encoding, multiplexing, modulating, transmitting, demodulating, demultiplexing, decoding, and the like, performed on different types of the left image 102 and the right image 103 to provide a 3D image to the user. The reception delay managing apparatus 101 may resolve an issue resulting from the difference between the reception delay times of the left image 102 and the right image 103, and enable the user to view normal and seamless content.

When one of the base view and the additional view is initially received by the reception delay managing apparatus 101, the reception delay managing apparatus 101 may wait until the base view or the additional view yet to be received is received. The reception delay managing apparatus 101 may provide substitution content during a waiting time for the user to view an image normally, thereby providing an image to the user seamlessly.

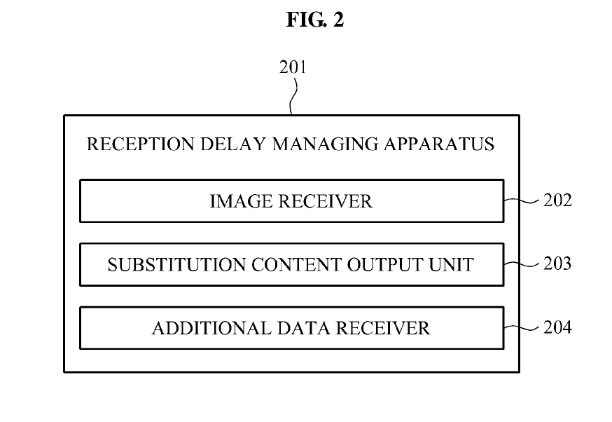

FIG. 2 is a block diagram illustrating a configuration of a reception delay managing apparatus 201 according to an exemplary embodiment.

Referring to FIG. 2, the reception delay managing apparatus 201 may include an image receiver 202, a substitution content output unit 203, and an additional data receiver 204.

The image receiver 202 may receive a left image and a right image for 3D image synthesis. The left image and the right image may be used as a base view or an additional view. The image receiver 202 may receive the left image and the right image at different points in time, depending on types of broadcasting network to be used for receiving the left image and the right image. In particular, the image receiver 202 may receive the left image and the right image at different points in time based on broadcasting networks that provide the base view and the additional view. In addition, the base view and the additional view may match the left image and the right image of the reception delay managing apparatus 201, and left and right positions thereof may be changed depending on a case. The image receiver 202 may receive the left image and the right image in response to power ON, a change of channel, 2D to 3D digital broadcast conversion, and the like.

The substitution content output unit 203 may output substitution content during a waiting time caused by a difference between the points in time at which the left image and the right image are received. The substitution content output unit 203 may determine the difference between the points in time at which the left image and the right image are received. The substitution content output unit 203 may verify the points in time at which the left image and the right image are received, depending on the types of broadcasting network, and determine the waiting time caused by the difference. When the left image is received prior to the right image, the waiting time may correspond to an interval from a point in time at which the left image is received to a point in time at which a right image matching the received left image is received. When the right image is received prior to the left image, the waiting time may correspond to an interval from a point in time the right image is received to a point in time at which a left image matching the received right image is received. The points in time at which the left image and the right image are received may refer to points in time at which the left image and the right image are stored in a buffer in an outputable form after demodulating, demultiplexing, and decoding operations of the left image and the right image are performed. The substitution content output unit 203 may output the substitution content that may substitute a 3D image requested by the user, during the waiting time. The substitution content may include image content, video content, advertisement content, music content, text content, and the like. In addition, the substitution content may include a one side image of a desired 3D broadcast, pre-stored content, or content of another broadcast channel.

For example, when the left image is initially received and the right image is received after the left image is received, the substitution content output unit 203 may verify the difference between the points in time at which the left image and the right image are received, and determine the waiting time caused by the difference. The substitution content output unit 203 may output the substitution content during the waiting time.

When the right image is received prior to the left image, the substitution content output unit 203 may play back a 2D image of a left image stream being previously provided until a left image matching the corresponding right image is received. The left image matching the corresponding right image may refer to a left image to be used for 3D image synthesis in response to power ON, a change of channel, and 2D to 3D digital broadcast conversion. The initially received right image may be stored in the buffer for 3D image synthesis. The substitution content output unit 203 may store the initially received right image in the buffer, and play back a 2D image of a left image of an image being previously provided during the waiting time until a left image to be used for 3D image synthesis is received. The image being previously provided may correspond to an image corresponding to the change of channel, or an image present during a process of converting an image currently being viewed from 2D to 3D.

When the left image is received prior to the right image, the substitution content output unit 203 may play back a 2D image of a right image stream being previously provided until a right image matching the corresponding left image is received. The substitution content output unit 203 may play back a 2D image of a right image being previously provided during the waiting time, through the same principle as the aforementioned method of playing back a 2D image of a left image yet to be received. In particular, the substitution content output unit 203 may store an initially received image in the buffer and play back a 2D image of another image being previously used, until the other image matching the initially received image is received, based on the initially received image between the left image and the right image.

The substitution content output unit 203 may display a notice message or a time remaining until the 3D image synthesis is performed, during the waiting time.

The additional data receiver 204 may receive additional data to be output as the substitution content during the waiting time. The additional data receiver 204 may receive the substitution content such as, for example, image content, video content, advertisement content, music content, text content, and the like, that may be output during the waiting time. The additional data receiver 204 may be omitted from the reception delay managing apparatus 201, depending on a scheme of outputting the substitution content during a reception delay time.

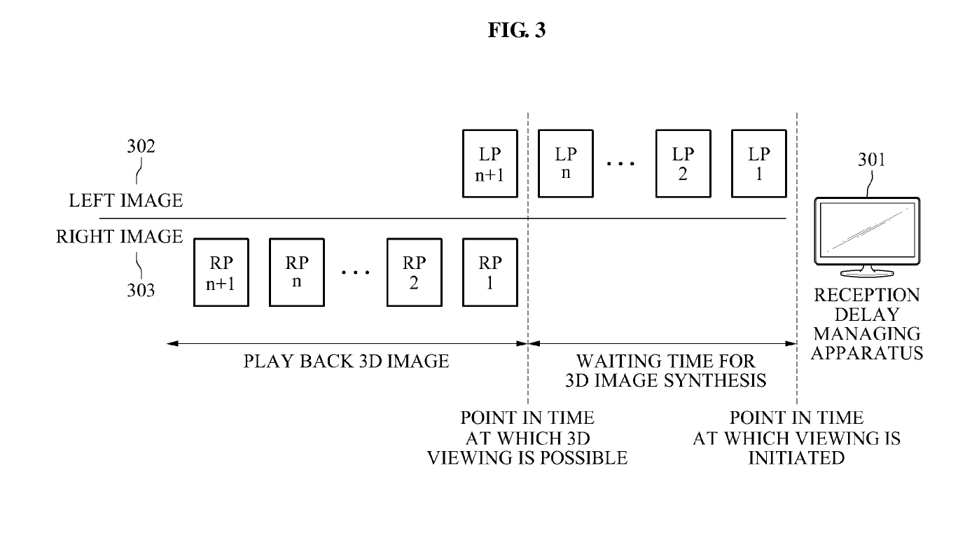

FIG. 3 is a diagram illustrating a process of determining substitution content according to an exemplary embodiment.

Referring to FIG. 3, a reception delay managing apparatus 301 may receive a left image 302 and a right image 303. The reception delay managing apparatus 301 may receive the left image 302 and the right image 303 at different points in time. For example, the reception delay managing apparatus 301 may receive the left image 302 prior to the right image 303. In this example, the left image 302 may refer to a base view, and the right image 303 may refer to an additional view. Left and right position of the left image 302 and the right image 303 may be changed depending on an actual implementation of the reception delay managing apparatus 301.

The reception delay managing apparatus 301 may wait until the right image 303 matching the initially received left image 302 is received, for 3D image synthesis. The reception delay managing apparatus 301 may synthesize a 3D image when both the left image 302 and the right image 303 to be used for 3D image synthesis are received. Accordingly, in the reception delay managing apparatus 301, a waiting time for 3D image synthesis may occur due to a difference between points in time at which the left image 302 and the right image 303 are received. The reception delay managing apparatus 301 may output substitution content during the waiting time for 3D image synthesis. The waiting time may be caused by the difference between the points in time at which the left image 302 and the right image 303 are received.

For example, the reception delay managing apparatus 301 may initially receive the left image 302 including a first left picture LP1 to an n^{th} left picture LPn. The reception delay managing apparatus 301 may subsequently receive the right image 303 including a first right picture RP1 to an n+1^{th} right picture RPn+1. The reception delay managing apparatus 301 may determine that a waiting time corresponds to an interval from a point in time at which the left image 302 is received to a point in time at which the right image 303 matching the left image 302 is received. The reception delay managing apparatus 301 may output substitution content during the determined waiting time.

The reception delay managing apparatus 301 may receive the left image 302 and the right image 303 matching the left image 302, synthesize a 3D image, and provide the 3D image to a user. For example, the reception delay managing apparatus 301 may synthesize a 3D image using the RP1 of the right image 303 and the LP1 of the initially received left image 302, based on a point in time at which the RP1 of the right image 303 is received.

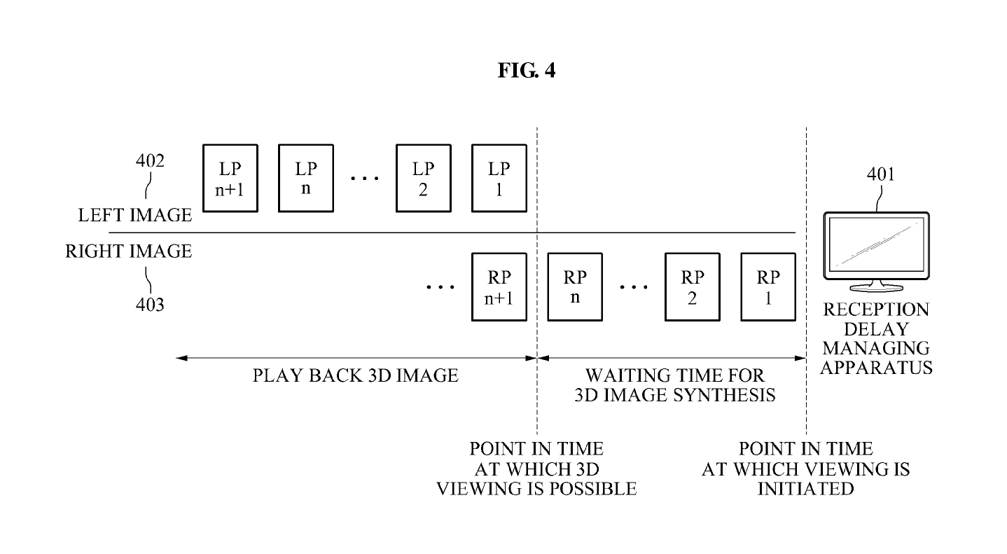

FIG. 4 is a diagram illustrating a process of determining substitution content according to another exemplary embodiment.

Referring to FIG. 4, a reception delay managing apparatus 401 may receive a left image 402 and a right image 403 at different points in time. For example, the reception delay managing apparatus 401 may receive the right image 403 prior to the left image 402. In this example, the left image 402 may refer to a base view, and the right image 403 may refer to an additional view. Left and right positions of the left image 402 and the right image 403 may be changed depending on an actual implementation of the reception delay managing apparatus 401.

The reception delay managing apparatus 401 may wait until the left image 402 matching the initially received right image 403 is received, for 3D image synthesis. The reception delay managing apparatus 401 may synthesize a 3D image when both the left image 402 and the right image 403 to be used for 3D image synthesis are received. The reception delay managing apparatus 401 may output substitution content during a waiting time for 3D image synthesis. The waiting time may be caused by a difference between points in time at which the left image 402 and the right image 403 are received. The reception delay managing apparatus 401 may synthesize the 3D image at a point in time at which both the left image 402 and the right image 403 are received, and provide the 3D image to a user.

For example, the reception delay managing apparatus 401 may initially receive the right image 403 including a first right picture RP1 to an n^{th} right picture RPn. The reception delay managing apparatus 401 may subsequently receive the left image 402 including a first left picture LP1 to an n+1^{th} left picture LPn+1. The reception delay managing apparatus 401 may determine that a waiting time corresponds to an interval from a point in time at which the right image 403 is received to a point in time at which the left image 402 matching the right image 403 is received. The reception delay managing apparatus 401 may output substitution content during the determined waiting time.

The reception delay managing apparatus 401 may receive the right image 403 and the left image 402 matching the right image 403, synthesize a 3D image, and provide the 3D image to the user. For example, the reception delay managing apparatus 401 may synthesize a 3D image using the LP1 of the left image 402 and the RP1 of the initially received right image 403, based on a point in time at which the LP1 of the left image 402 is received.

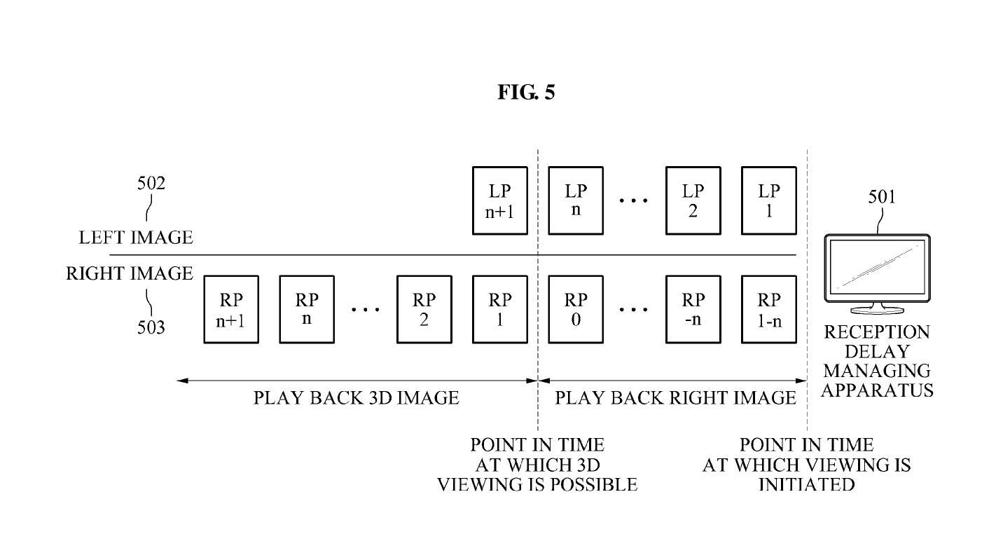

FIG. 5 is a diagram illustrating a process of outputting substitution content according to an exemplary embodiment.

Referring to FIG. 5, a reception delay managing apparatus 501 may receive a left image 502 prior to a right image 503. In this example, the left image 502 may correspond to a base view. When the left image 502 is initially received, the reception delay managing apparatus 501 may store the received left image 502 in a buffer until the right image 503 matching the left image 502 is received. The received left image 502 may be stored in the buffer since both the left image 502 and the right image 503 matching the left image 502 are required for 3D image synthesis. For example, the reception delay managing apparatus 501 may receive the left image 502 including a first left picture LP1 to an n^{th} left picture LPn and store the received left image 502 in the buffer. Since the reception delay managing apparatus 501 may synthesize and output a 3D image using both the left image 502 stored in the buffer and the subsequently received right image 503, there may be a difficulty in playing back the left image 502 during the reception delay. In this example, a user may not view a normal image. Accordingly, the reception delay managing apparatus 501 may output substitution content during a waiting time occurring until the right image 503 matching the left image 502 is received, thereby enabling the user to view a normal image.

The reception delay managing apparatus 501 may play back a 2D image of the right image 503 corresponding to an additional view during the waiting time, in lieu of the left image 502 corresponding to a base view. The reception delay managing apparatus 501 may receive the left image 502 based on a point in time at which 3D image viewing is initiated according to conditions such as, for example, power ON, a change of channel, 2D to 3D conversion, and the like, and play back a 2D image of a previous right image 503 until a right image 503 to be used for 3D image synthesis is received. The right image 503 to be used for 3D image synthesis may correspond to an image matching the initially received left image 502.

For example, the reception delay managing apparatus 501 may play back a 2D image of the right image 503 including a 1-n^{th} right picture RP1-n to a zeroth right picture RP0 until a first right picture RP1 of the right image 503 to be used for 3D image synthesis is received.

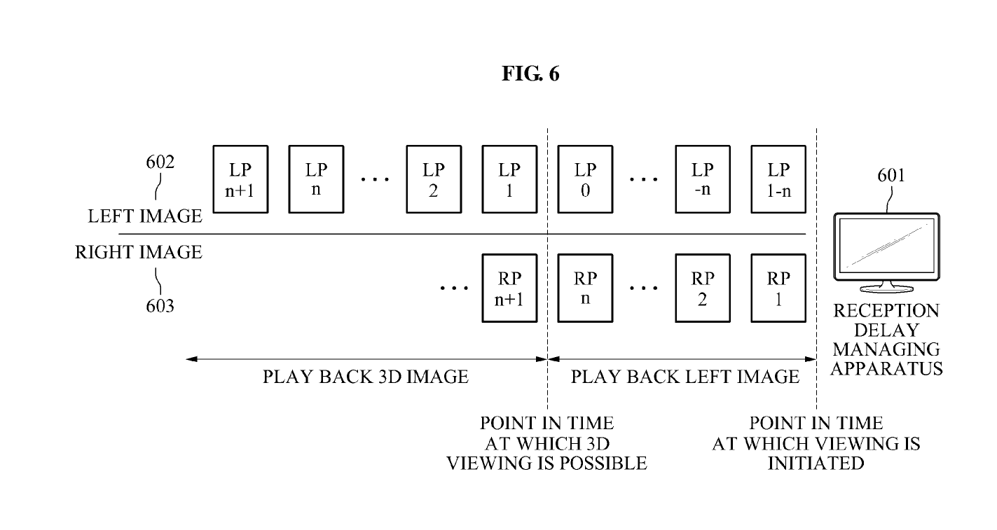

FIG. 6 is a diagram illustrating a process of outputting substitution content according to another exemplary embodiment.

Referring to FIG. 6, a reception delay managing apparatus 601 may receive a right image 603 prior to a left image 602. When the right image 603 is initially received, the reception delay managing apparatus 601 may store the received right image 603 in a buffer until the left image 602 matching the right image 603 is received. The received right image 603 may be stored in the buffer since both the right image 603 and the left image 602 matching the right image 603 are required for 3D image synthesis. For example, the reception delay managing apparatus 601 may receive the right image 603 including a first right picture RP1 to an n^{th} right picture RPn and store the received right image 603 in the buffer.

Since a frame of the right image 603 received at a point in time at which 3D image viewing is initiated corresponds to the RP1, the reception delay managing apparatus 601 may wait until a first left picture LP1 of the left image 602 matching the RP1 of the right image 603 is received. The reception delay managing apparatus 601 may not synthesize a 3D image until the right image 603 and the left image 602 corresponding to the right image 603 are received. Accordingly, the reception delay managing apparatus 601 may output substitution content during a waiting time occurring until the left image 602 to be used for 3D image synthesis is received.

The reception delay managing apparatus 601 may receive the right image 603 based on a point in time at which 3D image viewing is initiated according to conditions such as, for example, power ON, a change of channel, 2D to 3D conversion, and the like, and play back a 2D image of a previous left image 602 until a left image 602 to be used for 3D image synthesis is received. For example, the reception delay managing apparatus 601 may play back a 2D image of the left image 602 including a 1-n^{th} left picture LP1-n to a zeroth left picture LP0 until a first left picture LP1 of the left image 602 corresponding to a first right picture RP1 of the right image 603 is received.

When the LP1 of the left image 602 is received, the reception delay managing apparatus 601 may synthesize a 3D image using the LP1 of the left image 602 and the RP1 of the initially received right image 603. A point in time at which the LP1 of the left image 602 is received may correspond to a point in time at which 3D image viewing is possible through 3D image synthesis using the LP1 of the left image 602 and the RP1 of the right image 603.

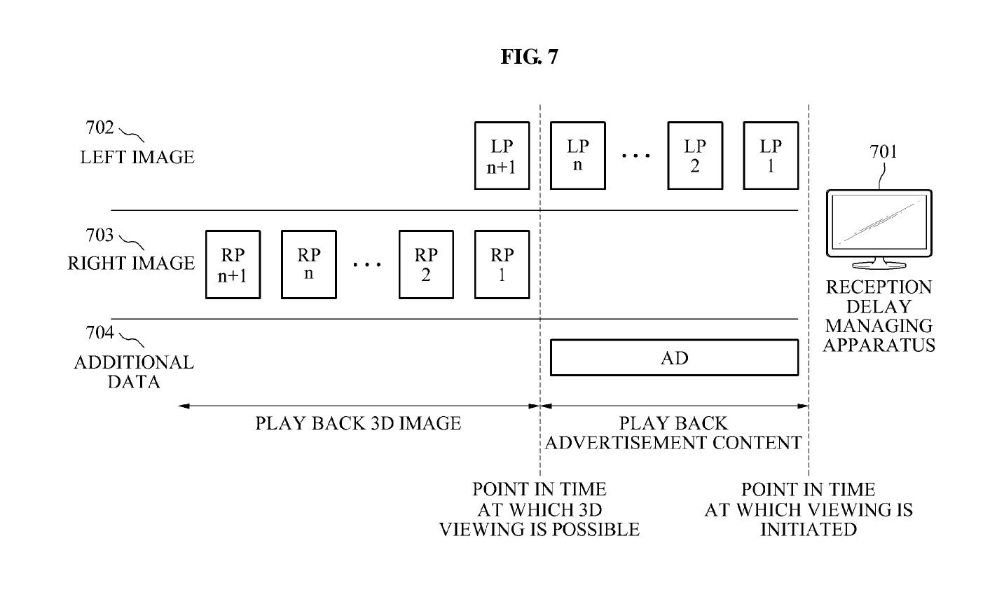

FIG. 7 is a diagram illustrating a process of outputting substitution content according to still another exemplary embodiment.

Referring to FIG. 7, a reception delay managing apparatus 701 may output substitution content during a waiting time caused by a difference between points in time at which a left image 702 and a right image 703 are received. The reception delay managing apparatus 701 may receive additional data 704 to be output as the substitution content during the waiting time. The additional data 704 may include image content, video content, advertisement content, music content, text content, and the like that may be utilized as the substitution content. In addition, the additional data 704 may include at least one of pre-stored content and content received through another broadcast channel.

The reception delay managing apparatus 701 may play back the substitution content corresponding to the additional data 704 during the waiting time between the left image 702 and the right image 703.

For example, the reception delay managing apparatus 701 may play back advertisement content for a period of time corresponding to a first left picture LP1 to an n^{th} left picture LPn of the left image 702 before a first right picture RP1 of the right image 703 is received. The advertisement content may include a video or a still image. The advertisement content may include content pre-stored through a broadband network, an NRT network, and the like, or another broadcast channel

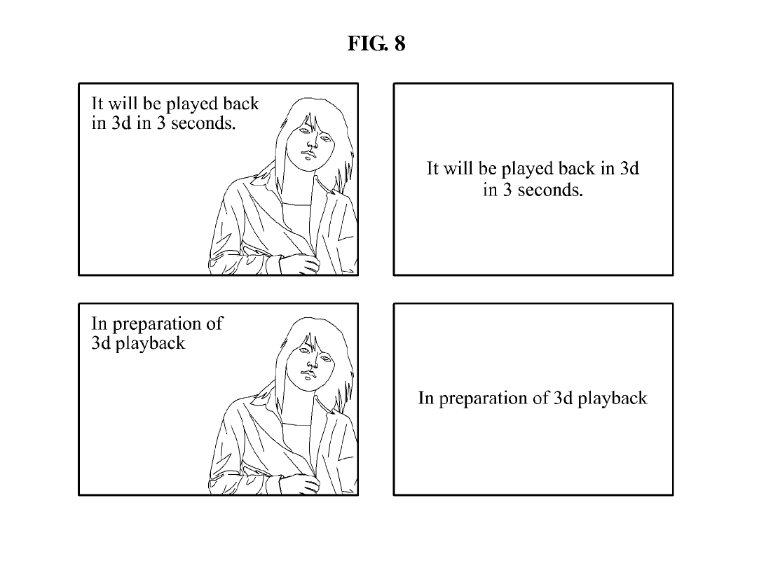

FIG. 8 is a diagram illustrating a method of displaying a waiting time for 3D image synthesis according to an exemplary embodiment.

Referring to FIG. 8, a reception delay managing apparatus may display a time remaining until 3D image synthesis is performed in a form of a notice. The remaining time may be displayed until an actual 3D image is synthesized using a left image and a right image and played back, after 3D viewing conversion is performed as shown in FIG. 8. The reception delay managing apparatus may display a waiting time or a notice message, along with or without a background, in order to inform a user of the remaining time.

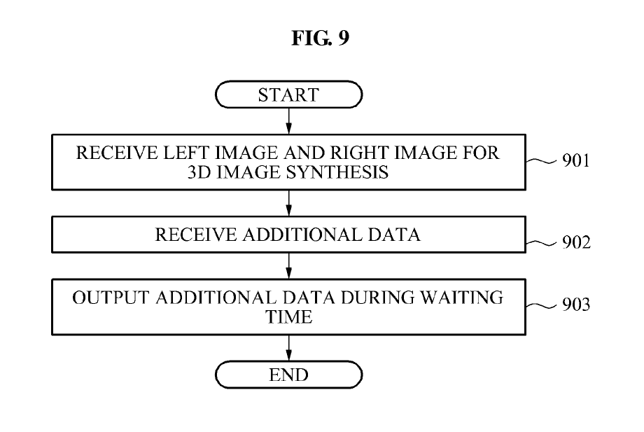

FIG. 9 is a flowchart illustrating a reception delay managing method according to an exemplary embodiment.

Referring to FIG. 9, in operation 901, a reception delay managing apparatus may receive a left image and a right image for 3D image synthesis. The reception delay managing apparatus may receive the left image and the right image at different points in time, depending on types of broadcasting network to be used for receiving the left image and the right image. The left image and the right image may correspond to a base view or an additional view, respectively. The left image and the right image may also correspond to an additional view and a base view, respectively, depending on a case.

In operation 902, the reception delay managing apparatus may receive additional data to be output as substitution content during a waiting time. The additional data may include image content, video content, advertisement content, music content, text content, and the like. Operation 902 may be omitted when a reception of separate additional content is unnecessary based on a scheme of outputting the substitution content in operation 903.

In operation 903, the reception delay managing apparatus may output the substitution content during the waiting time caused by a difference between the points in time at which the left image and the right image are received. The reception delay managing apparatus may verify the points in time at which the left image and the right image are received, depending on the types of broadcasting network, and determine the waiting time caused by the difference. The reception delay managing apparatus may play back the substitution content during the waiting time. For example, when the left image is initially received, the reception delay managing apparatus may play back a 2D image of a right image being previously provided until a right image corresponding to the received left image is received. When the right image is initially received, the reception delay managing apparatus may play back a 2D image of a left image being previously provided until a left image corresponding to the received right image is received. The reception delay managing apparatus may also play back the substitution content using the additional data received in operation 903.

According to an exemplary embodiment, an apparatus for managing a delay in receiving a 3D image may output substitution content during a waiting time caused by a difference between points in time at which a left image and a right image for 3D image synthesis are received, thereby effectively solving a delay in viewing the 3D image for a user viewing the 3D image.

According to an exemplary embodiment, an apparatus for managing a delay in receiving a 3D image may insert an advertisement as substitution content to be output during a waiting time caused by a difference between points in time at which a left image and a right image are received, thereby easily creating a profit model of an advertiser through the inserted advertisement.

The above-described exemplary embodiments of the present invention may be recorded in computer-readable media including program instructions to implement various operations embodied by a computer. The media may also include, alone or in combination to with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for managing a delay in receiving a three-dimensional (3D) image, the apparatus comprising:
an image receiver to receive a left image and a right image for 3D image synthesis; and
a substitution content output unit to output substitution content during a waiting time caused by a difference between points in time at which the left image and the right image are received.

2. The apparatus of claim 1, wherein, when the right image is received prior to the left image, the substitution content output unit plays back a two-dimensional (2D) image of the left image yet to be received, during the waiting time.

3. The apparatus of claim 1, wherein, when the left image is received prior to the right image, the substitution content output unit plays back a 2D image of the right image yet to be received, during the waiting time.

4. The apparatus of claim 1, wherein the substitution content output unit displays at least one of a notice message and a time remaining until the 3D image synthesis is performed, during the waiting time.

5. The apparatus of claim 1, wherein the substitution content comprises at least one of image content, video content, advertisement content, music content, and text content.

6. The apparatus of claim 1, wherein the substitution content comprises at least one of pre-stored content and content received through another broadcast channel.

7. The apparatus of claim 1, wherein, when the left image is received prior to the right image, the waiting time corresponds to an interval from a point in time at which the left image is received to a point in time at which the right image matching the received left image is received.

8. The apparatus of claim 1, wherein, when the right image is received prior to the left image, the waiting time corresponds to an interval from a point in time at which the right image is received to a point in time at which the left image matching the received right image is received.

9. The apparatus of claim 1, wherein the image receiver requests reception of the left image and the right image in response to at least one of power ON, a change of channel, and 2D to 3D digital broadcast conversion.

10. The apparatus of claim 1, further comprising:
an additional data receiver to receive additional data to be output as the substitution content during the waiting time.

11. A method of managing a delay in receiving a three-dimensional (3D) image, the method comprising:
receiving a left image and a right image for 3D image synthesis; and
outputting substitution content during a waiting time caused by a difference between points in time at which the left image and the right image are received.

12. The method of claim 11, wherein the outputting comprises, when the right image is received prior to the left image, playing back a two-dimensional (2D) image of the left image yet to be received, during the waiting time.

13. The method of claim 11, wherein the outputting comprises, when the left image is received prior to the right image, playing back a 2D image of the right image yet to be received, during the waiting time.

14. The method of claim 11, wherein the outputting comprises displaying at least one of a notice message and a time remaining until the 3D image synthesis is performed, during the waiting time.

15. The method of claim 11, wherein the substitution content comprises at least one of image content, video content, advertisement content, music content, and text content.

16. The method of claim 11, wherein the substitution content comprises at least one of pre-stored content and content received through another broadcast channel.

17. The method of claim 11, wherein, when the left image is received prior to the right image, the waiting time corresponds to an interval from a point in time at which the left image is received to a point in time at which the right image matching the received left image is received.

18. The method of claim 11, wherein, when the right image is received prior to the left image, the waiting time corresponds to an interval from a point in time at which the right image is received to a point in time at which the left image matching the received right image is received.

19. The method of claim 11, wherein the receiving comprises requesting reception of the left image and the right image in response to at least one of power ON, a change of channel, and 2D to 3D digital broadcast conversion.

20. The method of claim 11, further comprising:
receiving additional data to be output as the substitution content during the waiting time.
